(19) United States
(12) Patent Application Publication
(10) Pub. No.: US 2015/0109500 A1
(43) Pub. Date: Apr. 23, 2015

(54) IMAGE SENSOR INCLUDING SPREAD SPECTRUM CHARGE PUMP

(71) Applicant: OMNIVISION TECHNOLOGIES, INC., Santa Clara, CA (US)

(72) Inventors: Yuxin Wang, Sunnyvale, CA (US); Liping Deng, Cupertino, CA (US)

(73) Assignee: OMNIVISION TECHNOLOGIES, INC., Santa Clara, CA (US)

(21) Appl. No.: 14/057,841

(22) Filed: Oct. 18, 2013

(51) Int. Cl. H04N 5/357

(52) U.S. Cl. CPC H04N 5/357
USPC 348/294

(57) ABSTRACT

A method of reducing harmonic tones of noise in an image sensor includes generating a system clock and generating a random clock in response to the system clock. A charge pump is clocked with the random clock to generate a boosted voltage. The boosted voltage is provided to a pixel array of the image sensor. Image charge is readout from pixel cells of the pixel array using the boosted voltage from the charge pump.

### BACKGROUND INFORMATION

1. Field of the Disclosure

The present invention relates generally to image sensors. More specifically, examples of the present invention are related to circuits that readout image data from image sensor pixel cells with a charge pump.

2. Background

Image sensors have become ubiquitous. They are widely used in digital cameras, cellular phones, security cameras, as well as, medical, automobile, and other applications. The technology used to manufacture image sensors, and in particular, complementary metal-oxide-semiconductor (CMOS) image sensors, has continued to advance at great pace. For example, the demands of higher resolution and lower power consumption have encouraged the further miniaturization and integration of these image sensors.

In a conventional CMOS pixel cell, image charge is transferred from a photosensitive device (e.g., a photodiode) and is converted to a voltage signal inside the pixel cell on a floating diffusion node. The image charge can be readout from the pixel cell into readout circuitry and then processed. In an image sensor application, a charge pump provides a boosted voltage (i.e., higher than a normal V_{DD} level) to an array of pixel cells in order to readout the image charges from photodiodes in the pixel cells and pass along a voltage signal through a readout path to the readout circuitry.

A charge pump can be driven by a system clock. The charging and discharging phases of the charge pump operate along with the system clock, which can generate a significant amount of noise. The power spectrum of the harmonic tones of the generated noise is aligned with those of the system clock. In other words, the harmonic tones of the noise are aligned with those of the system clock, which can propagate throughout the imaging system and reduce the dynamic range and therefore the image quality of images acquired with the imaging system.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an example of a portion of an imaging system including a charge pump with a random clock to reduce harmonic tones of the system clock in accordance with the teachings of the present invention.

FIG. 2A is a schematic illustrating one example of a charge pump coupled to be clocked with a random clock in an image sensor in accordance with the teachings of the present invention.

FIG. 2B is a schematic illustrating one example of a synchronized two phase non-overlapping clock generator coupled to clock a charge pump in an image sensor in accordance with the teachings of the present invention.

FIG. 3A is a block diagram illustrating one example of a system clock coupled to a random clock generator coupled to generate a random clock to clock a charge pump in an image sensor in accordance with the teachings of the present invention.

FIG. 3B is a block diagram illustrating one example of a random clock generator coupled to generate a random clock in accordance with the teachings of the present invention.

FIG. 3C is a state diagram with a timing diagram illustrating operation of one example of a random clock generator coupled to generate a random clock to clock a charge pump in an image sensor in accordance with the teachings of the present invention.

FIG. 4 is a block diagram illustrating another example of a random clock generator coupled to generate a random clock in accordance with the teachings of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Examples in accordance with the teaching of the present invention describe a charge pump coupled to operate with a random clock in an image sensor in accordance with the teachings of the present invention. As mentioned previously, in an image sensor application, a charge pump provides a boosted voltage (i.e., higher than the normal V_{DD} level) to an array of pixel cells in order to readout the image charges from photodiodes and pass along a voltage signal through a readout path to readout circuitry. The charge pump can be driven by a clock, which can generate a significant amount of undesired noise having harmonic tones that are aligned with those of the system clock. These harmonic tones can propagate throughout the power lines of the image sensor as well as the entire semiconductor substrate. Consequently, these harmonic tones will be added on the noise floor, which can negatively affect the image quality of the image sensor.

As will be discussed, in order to improve the image quality, the level of the harmonic tones is reduced with a charge pump coupled to operate with a random clock in an image sensor in accordance with the teachings of the present invention. In order to reduce the harmonic tones generated by the charge pump, the charging and discharging operations are be randomized. However, in order to reduce the reverse charge leakage from each stage of the charge pump, the randomized charging and discharging operations are synchronized in the stages of the charge pump. In one example, this synchronization with randomized operations is achieved with synchronized two non-overlapping clock phases generated in response to a randomized system clock.

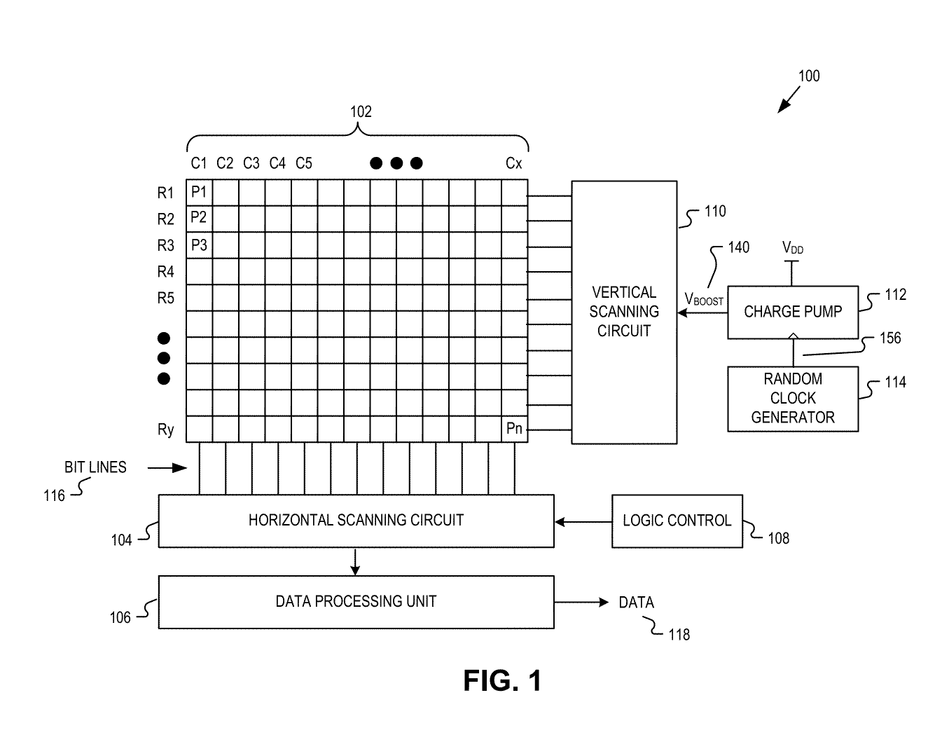

To illustrate, FIG. 1 is a block diagram illustrating an example of a portion of an imaging system including a charge pump with a random clock to reduce harmonic tones of the system clock in accordance with the teachings of the present invention. As shown in the depicted example, a portion of imaging system 100 includes an array of pixel cells 102 coupled to a vertical scanning circuit 110 and readout circuitry, which in the illustrated example is shown as horizontal scanning circuit 104. In the example, a charge pump 112 is coupled to receive a voltage V_{DD} and a random clock signal 156 from a random clock generator 114. Charge pump 112 is coupled to provide a boosted voltage V_{BOOST} 140 to vertical scanning circuit 110, which provides the boosted voltage V_{BOOST} 140 to array of pixel cells 102.

As shown in the example, pixel array 102 is a two-dimensional (2D) array of imaging sensors or pixel cells (e.g., pixel cells P1, P2 . . . , Pn). In one example, each pixel cell is a CMOS imaging pixel. As illustrated, each pixel cell is arranged into a row (e.g., rows R1 to Ry) and a column (e.g., column C1 to Cx) to acquire image data of a person, place, object, etc., which can then be used to render a 2D image of the person, place, object, etc.

In one example, after each pixel cell has accumulated its image data or image charge, the boosted voltage V_{BOOST} 140 is provided to the array of pixel cells 102 through vertical scanning circuit 110 to readout image charge from photodiodes included in the pixel cells of the array of pixels 102 and also to pass along the signals along the readout path through bitlines 116 to horizontal scanning circuit 104. In one example, a logic circuit 108 can control the horizontal scanning circuit 104 and output image data to a data processing unit 106. In various examples, the readout circuitry including horizontal scanning circuit 104 may also include additional amplification circuitry, additional analog-to-digital (ADC) conversion circuitry, or otherwise. Data processing unit 106 may simply store the image data or even manipulate the image data by applying post image effects (e.g., crop, rotate, remove red eye, adjust brightness, adjust contrast, or otherwise). In one example, horizontal scanning circuit 104 may readout a row of image data at a time along readout column bit lines 116 (illustrated) or may readout the image data using a variety of other techniques (not illustrated), such as a serial readout or a full parallel readout of all pixels simultaneously.

In one example, control circuitry including vertical scanning circuit 110 may be coupled to control operational characteristics of the array of pixels 102. For example, the control circuitry may generate a shutter signal for controlling image acquisition. In one example, the shutter signal is a global shutter signal for simultaneously enabling all pixels within the array of pixels 102 to simultaneously capture their respective image data during a single acquisition window. In another example, the shutter signal is a rolling shutter signal such that each row, column, or group of pixels is sequentially enabled during consecutive acquisition windows.

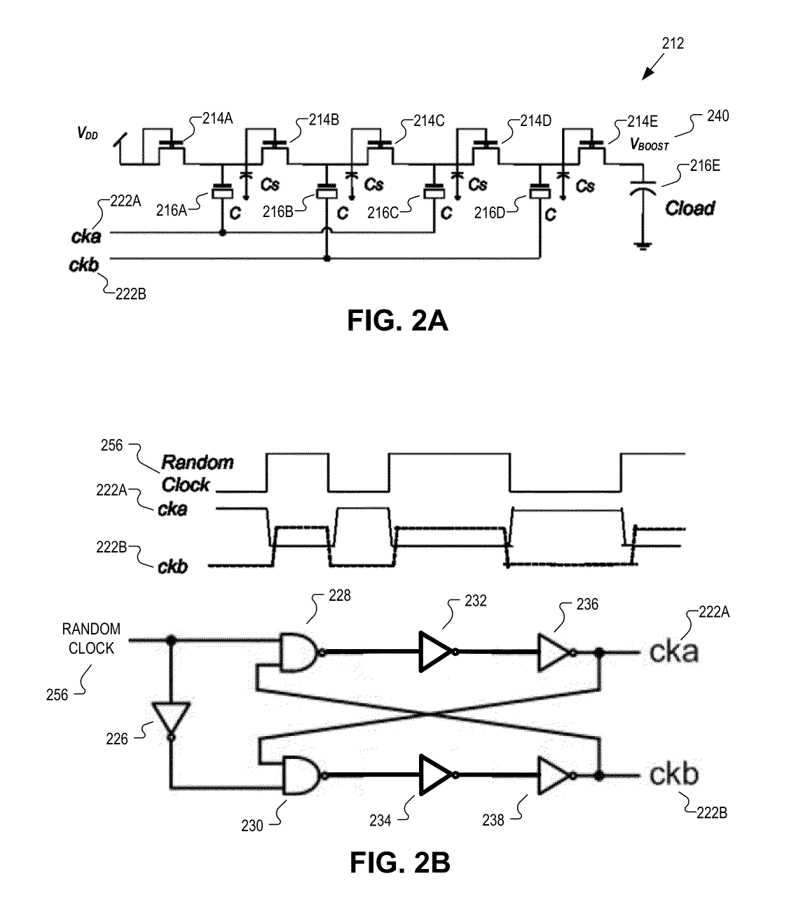

FIG. 2A is a schematic illustrating one example of a charge pump 212 coupled to be clocked with a random clock in an image sensor in accordance with the teachings of the present invention. In one example, it is appreciated that charge pump 212 of FIG. 2A is one of example of charge pump 112 of FIG. 1. Accordingly, it should be appreciated that similarly named and numbered elements referenced below are coupled and function as described above. In the depicted example, charge pump 212 is a Dickson charge pump. In other examples, it is appreciated that other types of charge pumps can also be utilized such as for example a voltage doubler type charge pump, or the like.

In the example depicted in FIG. 2A, charge pump 212 includes a plurality of diode-coupled transistors 214A, 214B, 214C, 214D, and 214E coupled to a plurality of capacitors 216A, 216B, 216C, 216D, and 216E as shown. In the example, voltage V_{DD} is coupled to diode-coupled transistor 214A, capacitors 216A and 216C are coupled to receive a random clock signal cka 222A, and capacitors 216B and 216D are coupled to receive a random clock signal ckb 222B as shown. As will be discussed in further detail below, random clock signals cka 222A and ckb 222B are synchronized two phase non-overlapping random clock signals that are generated in response to a random clock 256 in accordance with the teachings of the present invention. In one example, clock signals cka 222A and ckb 222B are synchronized non-overlapping antiphase signals that swing between voltage rails. For purposes of explanation herein, it may be assumed that clock signals cka 222A and ckb 222B swing between voltage rails of 0V and V_{DD}, although it is appreciated that clock signals cka 222A and ckb 222B may also swing between other voltage rail values in accordance with the teachings of the present invention.

In operation, when clock signal cka 222A is low, diode-coupled transistor 214A is coupled to charge the voltage across capacitor 216A to V_{DD}. When clock signal cka 222A goes high, the voltage at the top plate of capacitor 216A is pushed up to 2V_{DD}. At this point, diode-coupled transistor 214A is turned off, and diode-coupled transistor 214B is turned on, at which point capacitor 216B is charged to 2V_{DD} from capacitor 216A. On the next clock cycle, clock signal cka 222A goes low and clock signal ckb 222B goes high, which pushes up the voltage at the top plate of capacitor 216B to 3V_{DD}. At this point, diode-coupled transistor 214B is turned off, and diode-coupled transistor 214C is turned on, at which point capacitor 216C is charged to 3V_{DD} from capacitor 216B.

This charging of the capacitors continues down the chain of stages of charge pump 212 through diode-coupled transistors 214D and 214E to capacitors 216D and 216E such that a boosted voltage V_{BOOST} 240 is provided across capacitor 216E, which may also be referred to as an output load capacitor of charge pump 212 that provides smoothing. Indeed, as shown in the depicted example, capacitor 216E is coupled to a ground terminal instead of one of the clock signals cka 222A or ckb 222B.

FIG. 2B is a schematic illustrating one example of a synchronized two phase non-overlapping clock generator coupled to clock a charge pump in an image sensor in accordance with the teachings of the present invention. In one example, the circuitry of the synchronized two phase non-overlapping clock generator shown in FIG. 2B may be included in charge pump 212 shown in FIG. 2A. As shown in the depicted example, the two phase non-overlapping clock generator shown in FIG. 2B generates the synchronized two phase non-overlapping random clock signals cka 222A and 222B in response to a random clock 256. In the example, the two phase non-overlapping clock generator includes cross-coupled NAND gates 228 and 230. In one example, a first plurality of inverters 232 and 236 is coupled to an output of NAND gate 228, and a second plurality of inverters 234 and 238 is coupled to an output of NAND gate 230. In other examples, it is appreciated that other types of circuits can also be employed for the first and second pluralities of inverters 232, 234, 236, 238, such as for example driver circuits or the like. As shown in the example, clock signal cka 222A is generated at an output of inverter 236, which is also provided to an input of NAND gate 230, and clock signal ckb 222B is generated at an output of inverter 238, which is also provided to an input of NAND gate 228. In the example, random clock is 256 is coupled to another input of NAND gate 228, and an inversion of random clock 256 is coupled to another input of NAND gate 230 through inverter 230 as shown.

As shown in the example illustrated in FIG. 2B, clock signals cka 222A and ckb 222B are generated in response to random clock 256. In addition, clock signals cka 222A and ckb 222B are synchronized non-overlapping signals, which help to prevent the reverse leakage of charge from each stage of charge pump 212, as discussed above in FIG. 2A. Therefore, with clock signals cka 222A and ckb 222B, the charging and discharging in charge pump 212 are achieved with synchronized and randomized operations in response to random clock 256 in accordance with the teachings of the present invention.

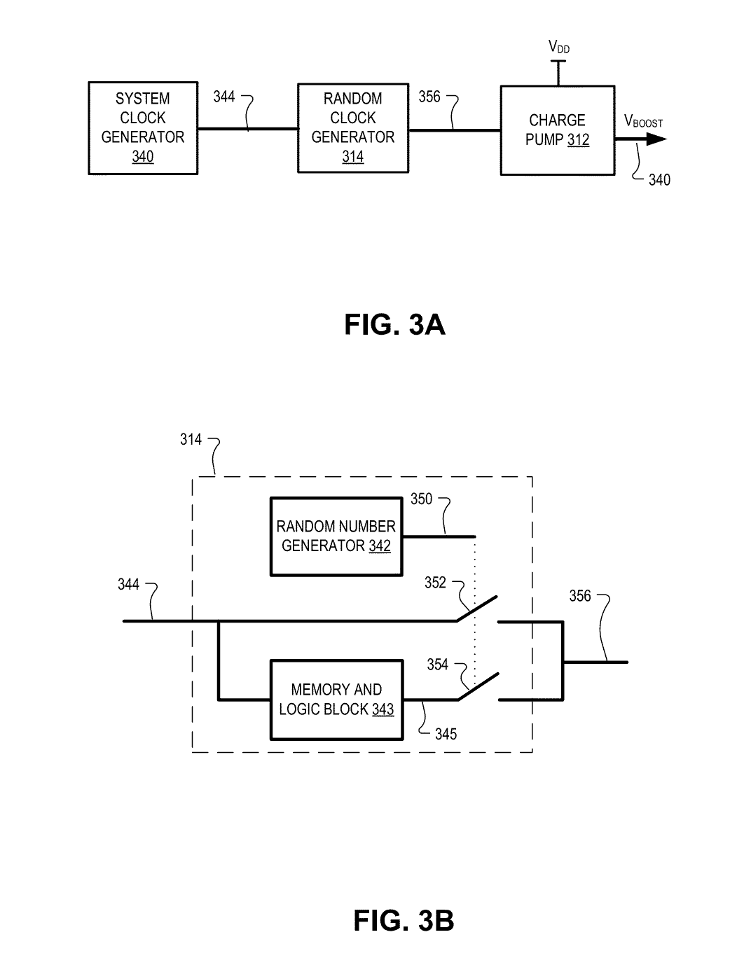

FIG. 3A is a block diagram illustrating a system clock coupled to a random clock generator 314 coupled to generate a random clock 356 coupled to clock a charge pump 312 in an image sensor in accordance with the teachings of the present invention. In one example, it is appreciated that random clock generator 314 and charge pump 312 may be examples of random clock generator 114 and charge pump 112 of FIG. 1, or of charge pump 212 of FIGS. 2A-2B. Accordingly, it should be appreciated that similarly named and numbered elements referenced below are coupled and function as described above. As shown in the depicted example, random clock generator 342 includes a system clock generator 340 that is coupled to generate a system clock 344.

FIG. 3B is a block diagram illustrating one example of random clock generator 314 coupled to generate random clock 356 in accordance with the teachings of the present invention. As shown in the depicted example, random clock generator 314 includes memory and logic block 343, random number generator 342, and switches 352 and 354. In one example, memory and logic block 343 is coupled to receive system clock 344 and is coupled to generate an inversion of a previous clock cycle of the random clock 345. Random number generator 342 is coupled to generate a random sequence 350. In one example, random clock generator 342 generates random sequence 350 using a 1-bit digital delta-sigma modulator dithering. It is appreciated that such delta-sigma modulation may be employed to generate the random sequence 350 in accordance with the teachings of the present invention

In one example, switches 352 and 354 are switched in response to random sequence 350 to select one of system clock 344 or the inversion of the previous cycle of the random clock 345 to generate random clock 356 as shown in accordance with the teachings of the present invention. For instance, in one example, the random clock 356 that is generated by random clock generator 314 is coupled to be equal to the system clock 344 if the random sequence 350 is representative of a first state, such as for example “0.” In one example, random clock 356 is coupled to be equal to the inverse of the previous cycle of the random clock 345 if the random sequence 350 is representative of a second state, such as for example “1.” Thus, in one example, switches 352 and 354 are switched accordingly in response to random sequence 350 to select the appropriate signal in order to generate the random clock 356 in accordance with the teachings of the present invention.

To illustrate, FIG. 3C is a state diagram illustrating operation of one example of a random clock generator 314 coupled to generate a random clock 356 to clock a charge pump 312 in an image sensor in accordance with the teachings of the present invention. As shown in FIG. 3C, processing begins in state 358, which shows that in one example, random clock generator 314 first uses only the system clock 344 as random clock 356 during startup when the random clock generator 314 is first awoken. For instance, in this example, when the charge pump 312 is first woken up from standby mode, the random clock operation is disabled during startup so that the charge pump 312 output V_{BOOST} 340 may be quickly charged to at least a threshold value. In one example, startup is complete when the output V_{BOOST} 340 reaches the threshold value.

Next, after startup is complete, processing continues to state 360 where the system clock and a random number of the random sequence are generated. If the random number is representative of a first state, or for example equal to “0,” then processing continues to state 364. If the random number is representative of a second state, or for example equal to “1,” then processing continues to state 362.

As shown in state 364, if the random number equals “0,” then the random clock 356 equals the system clock 344, and then processing loops back to state 360 for the next cycle where the next system clock cycle and random number are generated.

As shown in state 362, if the random number equals “1,” then the random clock 356 equals the inverse of the previous cycle of the random clock 345, and then processing loops back to state 360 for the next cycle where the next system clock cycle and random number are generated.

To illustrate, as shown in the timing diagram of FIG. 3C, at time t0, it is assumed that the random number equals “1,” and that the random clock 356 equals the inversion of the previous cycle of the random clock 345. At time t1, it is assumed that the random number equals “0,” and that the random clock 356 equals the system clock 344 at time t1. At time t2, the random number equals “1,” and the random clock 356 therefore equals the inversion of the previous cycle of the random clock 345 (i.e., the random clock 356 cycle at time t1). At time t3, the random number equals “1,” and the random clock 356 therefore equals the inversion of the previous cycle of the random clock 345 (i.e., the random clock 356 cycle at time t2). At time t4, the random number equals “0,” and the random clock 356 therefore equals the system clock. At time t5, the random number equals “1,” and the random clock 356 therefore equals the inversion of the previous cycle of the random clock 345 (i.e., the random clock 356 cycle at time t4). At time t6, the random number equals “0,” and the random clock 356 therefore equals the system clock. At time t7, the random number equals “0,” and the random clock 356 therefore equals the system clock.

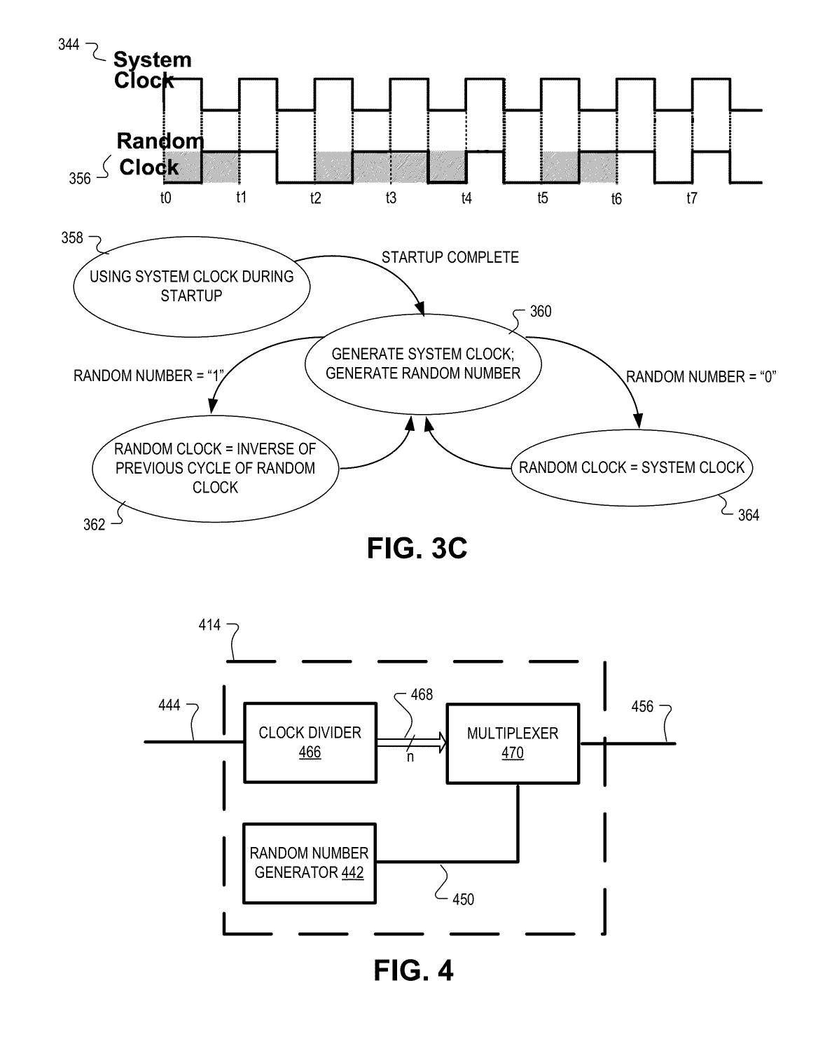

FIG. 4 is a block diagram illustrating another example of a random clock generator 414 that is coupled to generate a random clock 456 in accordance with the teachings of the present invention. In one example, it is appreciated that random clock generator 414 may be another example of random clock generator 114 of FIG. 1, or of random clock generator 314 of FIGS. 3A-3C. Accordingly, it should be appreciated that similarly named and numbered elements referenced below are coupled and function as described above.

As shown in the example depicted in FIG. 4, random clock generator 414 includes a clock divider 466, a multi-bit random number generator 442, and a multiplexer 470 coupled as shown. In the illustrated example of random clock generator 414, clock divider 466 generates a plurality of divided clocks 468 in response to system clock 444. Thus, if the period of system clock 444 is T, then one example of divided clocks 468 may have periods that are multiples of T, such as for example 1.25T, 1.5T, 1.75T, 2T, etc. In one example, clock divider 466 generates n divided clocks, where n may be an integer greater than 3. In one example, n=8 and clock divider 466 therefore generates 8 divided clocks 468. In the example, multiplexer 470 is an n-to-1 multiplexer that selects one of the n divided clocks 468. In the example, multi-bit random number generator 442 generates a sequence of multi-bit random numbers 450, with each random number having equal probability of occurring in the sequence of multi-bit random numbers 450. In the example, multiplexer 470 is coupled to select in response to the sequence of multi-bit random numbers 450 one of the divided clocks 468 to output to random clock 456. In the example, random clock 456 is coupled to be received by a charge pump to clock the charge pump in accordance with the teachings of the present invention. In one example, multi-bit random number generator generates multi-bit random numbers 450 using a multi-bit digital delta-sigma modulator with dithering.

It is appreciated of course that the example techniques described above are only examples of generating a random clock to clock a charge pump in an image sensor and that other techniques may be utilized to generate the random clock in accordance with the teachings of the present invention. By utilizing the random clock to clock the charge pump of an image sensor in accordance with the teachings of the present invention as described above, it is appreciated that the image quality of an image acquired by an image sensor is improved because the level of harmonic tones is reduced in the power spectrum of the noise levels in the imaging system in accordance with the teachings of the present invention. Therefore, less harmonic tones will be propagated through the power lines and semiconductor substrate of the entire system, which would have otherwise been added to the noise floor and eventually impact image quality.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A method of reducing harmonic tones of noise in an image sensor, comprising:
generating a system clock;
generating a random clock in response to the system clock;
clocking a charge pump with the random clock to generate a boosted voltage;
providing the boosted voltage to a pixel array of the image sensor; and
reading out image charge from pixel cells of the pixel array using the boosted voltage from the charge pump.

2. The method of claim 1 further comprising clocking the charge pump with the system clock during startup, wherein said clocking the charge pump with the random clock to generate the boosted voltage occurs after startup.

3. The method of claim 2 wherein startup is completed after the boosted voltage provided by the charge pump reaches a threshold level.

4. The method of claim 1 wherein generating the random clock comprises:
generating a random number;
setting the random clock to equal an inverse of a previous cycle of the random clock if the random number is representative of a first state; and
setting the random clock to equal system clock if the random number is representative of a second state.

5. The method of claim 4 wherein generating the random number comprises generating a random sequence with a delta-sigma modulator.

6. The method of claim 1 wherein clocking the charge pump with the random clock to generate the boost voltage comprises:
generating synchronized two phases of a non-overlapping clock in response to the random clock; and
driving the charge pump with the synchronized two phases of the non-overlapping clock, wherein charging and discharging phases of the charge pump are responsive to the synchronized two phases of the non-overlapping clock.

7. The method of claim 1, wherein generating the random clock comprises:
generating a sequence of random numbers;
dividing the system clock to generate a plurality of divided clocks; and
selecting one of the plurality of divided clocks in response to the sequence of random numbers to generate the random clock.

8. An image sensing system, comprising:
an array of pixel cells arranged into a plurality of rows and a plurality of columns;
a charge pump coupled to provide a boosted voltage to the array of pixel cells;
a random clock generator coupled to clock the charge pump; and
readout circuitry coupled to the array of pixel cells to readout image charge from the array of pixel cells using the boosted voltage provided from the charge pump.

9. The image sensing system of claim 8 further comprising a vertical scanning circuit coupled between the array of pixel cells and the charge pump, wherein the charge pump is coupled to provide the boosted voltage to the array of pixel cells through the vertical scanning circuit.

10. The image sensing system of claim 8 wherein the readout circuitry comprises a horizontal scanning circuit coupled to array of pixel cells through a plurality of bitlines.

11. The image sensing system of claim 8 further comprising a data processing unit coupled to the readout circuitry to process the image charge readout from the array of pixel cells.

12. The image sensing system of claim 8 further comprising a logic control circuit coupled to the readout circuitry to control the readout of the image charge from the array of pixel cells using the boosted voltage provided from the charge pump.

13. The image sensing system of claim 8 wherein the charge pump comprises a Dickson charge pump coupled to clocked in response to the random clock.

14. The image sensing system of claim 8 further comprising a two phase non-overlapping clock generator coupled to generate synchronized two phase non-overlapping clock signals to clock the charge pump in response to the random clock generator.

15. The image sensing system of claim 14 wherein the synchronized two phase non-overlapping clock generator comprises:
cross-coupled NAND gates;
a first plurality of inverters coupled to an output of a first one of the cross-coupled NAND gates;
a second plurality of inverters coupled to an output of a second one of the cross-coupled NAND gates; and
an input inverter coupled to an input of the second one of the cross-coupled NAND gates, wherein the first one of cross-coupled NAND gates is coupled to receive the random clock and wherein the second one of the cross-coupled NAND gates is coupled to receive an inverted random clock through the input inverter.

16. The image sensing system of claim 8 wherein the random clock generator comprises:
a system clock generator coupled to generate a system clock; and
a random number generator coupled to generate a random sequence, wherein a random clock generated by the random clock generator is coupled to equal the system clock if the random sequence is representative of a first state, and wherein the random clock generated by the random clock generator is coupled to equal an inverse of a previous cycle of the random clock if the random sequence is representative of a second state.

17. The image sensing system of claim 16 wherein the random clock generator comprises a delta-sigma modulator.

18. The image sensing system of claim 16 wherein the random clock generator comprises a fractional-N phase lock loop.

19. The image sensing system of claim 8 wherein the random clock generator comprises:
a clock divider coupled to receive a system clock to generate a plurality of divided clocks;
a random number generator coupled to generate a random sequence of numbers; and
a multiplexer coupled the clock divider and the random number generator to select one of the plurality of divided clocks in response to the random sequence of numbers to generate the random clock.
